(19) United States
(12) Patent Application Publication
(10) Pub. No.: US 2026/0079752 A1
(43) Pub. Date: Mar. 19, 2026

(54) AUTOMATICALLY ALLOCATING TASKS TO RESOURCES

(71) Applicant: INTERNATIONAL BUSINESS MACHINES CORPORATION, Armonk, NY (US)

(72) Inventors: Sanket Jain, Gurgaon (IN); Saurabh Kochhar, New Delhi (IN); Bibhushan ., Karnataka (IN); Niraj Ranjan Sharma, Kolkata (IN); Ratnakar Behera, Bangalore (IN); Sukumar Beri, New Delhi (IN)

(21) Appl. No.: 18/890,296

(22) Filed: Sep. 19, 2024

(51) Int. Cl. G06F 9/50

(52) U.S. Cl. CPC G06F 9/5027

(57) ABSTRACT

Systems, methods, and computer program products for automatically allocating tasks to resources using a machine learning model and a hypergraph are described herein. A method comprises receiving workflow information characterizing one or more updates to the task management environment; providing the workflow information as input to the machine learning model; generating, by the machine learning model, a candidate task allocation based on the workflow information and the hypergraph information; updating the hypergraph information in accordance with the workflow information; determining a weight for each of the one or more updates; selecting an individual update of the one or more updates such that the weight of the individual update is greater than or equal to a weight threshold; and updating the machine learning model to reflect the individual update.

### BACKGROUND

Embodiments of the present disclosure relate to automatically allocating tasks to resources within task management environments, and more specifically, to performing such allocation using a combination of a machine learning model and a hypergraph. A task management environment is a setting in which, or a group of entities by which, units of work are completed. Exemplary task management environments include airports, companies, teams within companies, stores, other groups of people, and/or other settings.

### SUMMARY

According to embodiments of the present disclosure, methods of and computer program products for automatically allocating tasks to resources are disclosed. A method for automatically allocating tasks to resources may include storing hypergraph information and a machine learning model. In some implementations, the said hypergraph information and the said machine learning model are stored in a set of one or more computer-readable storage media. In some implementations, the said hypergraph information characterizes a task management environment. In some implementations, the said machine learning model is configured to output task allocations for the said task management environment responsive to receipt of information indicating a change to the said task management environment. A method for automatically allocating tasks to resources may include receiving workflow information characterizing one or more updates to the said task management environment. In some implementations, the said updates include a task to be allocated to at least one resource. In some implementations, the said workflow information is received from a client computing platform. A method for automatically allocating tasks to resources may include providing the said workflow information as input to the said machine learning model. The said method for automatically allocating tasks to resources may include generating a candidate task allocation based on the said workflow information and the said hypergraph information. In some implementations, the said candidate task allocation is generated by the said machine learning model.

The said method for automatically allocating tasks to resources may include updating the said hypergraph information in accordance with the said workflow information. The said method for automatically allocating tasks to resources may include determining a weight for each of the said one or more updates. The said method for automatically allocating tasks to resources may include selecting an update of the said one or more updates such that the weight of the said update is greater than or equal to a weight threshold. The said method for automatically allocating tasks to resources may include updating the said machine learning model to reflect the said update.

### BRIEF DESCRIPTION OF THE DRAWINGS

FIG. 1 is a flow diagram depicting an exemplary method for automatically allocating tasks to resources, in accordance with one or more embodiments of this disclosure.

FIG. 2 is a block diagram depicting a process for automatically allocating tasks to resources, in accordance with one or more embodiments of this disclosure.

FIG. 3 is a schematic diagram of a computing node according to embodiments of the present disclosure.

### DETAILED DESCRIPTION

Resource management tools and software are generally managed directly by individuals. These individuals allocate or allot units of work (i.e., tasks) to resources. Resources may include one or more people, one or more locations, one or more objects, and/or one or more other entities. For example, a resource may be a member of a team capable of working on and/or completing tasks for the team. As another example, a resource may be an airplane capable of being designated for use during particular flights for an airline. In such an example, the particular flights may be considered to be tasks. Due to the manual nature of current tools and software, when a new task is introduced to the task management environment, managers must apply their own judgement whether to assign it to a particular resource. This may result in task allocations that are not optimal due to an inability of an individual to manage large amounts of complex information characterizing the current tasks and the resources of the task management environment. The lack of optimization and the time spent by managers to determine task allocations can cause undue expenses for the task management environment.

Accordingly, there is a need for an artificial intelligence approach to task allocation that takes into consideration historic and present characteristics of the task management environment. Embodiments of the present disclosure are directed to automatically allocating a task to a resource. Allocating the said task to the said resource may include providing a recommendation of such an allocation to a manager of the task management environment. Embodiments of the present disclosure generate candidate task allocations by a machine learning model (e.g., a large language model) particularly tuned for using information stored in a hypergraph. The machine learning model may use stored information regarding the task management environment and the said information stored in the said hypergraph for generating candidate task allocations. The use of information encoded in the machine learning model in combination with information stored in a hypergraph by the machine learning model may enable the machine learning model to understand context for a current state of the task management environment and historical information characterizing the task management environment. Additionally, the use of a hypergraph enables memory allocated to the machine learning model to be optimized. Such optimizations to memory as described herein may enable the machine learning model to generate more optimal candidate task allocations using a wide view of the task management environment, without the need for extensive computer-readable storage media and/or increased processing time.

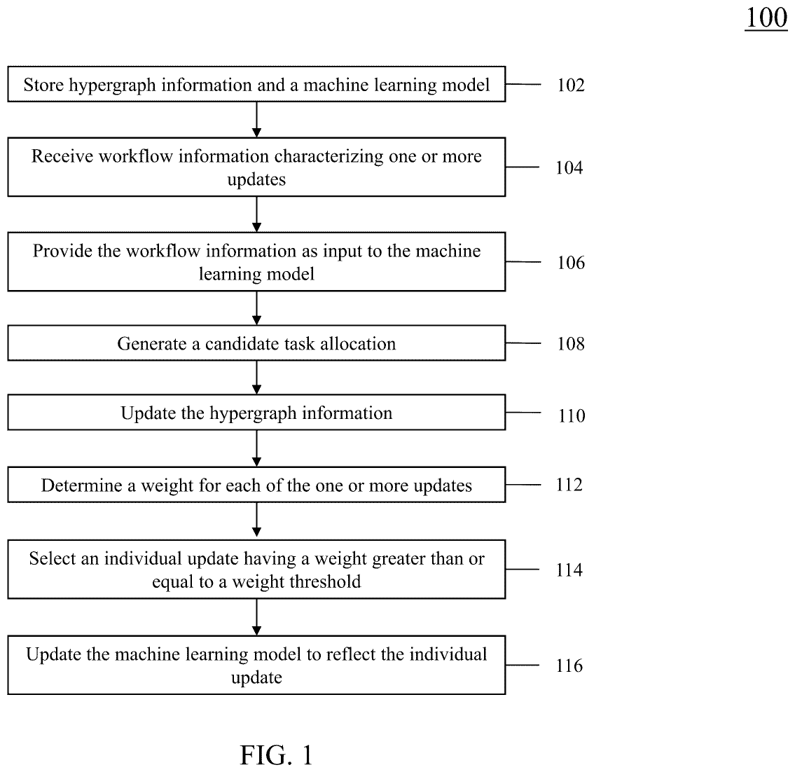

FIG. 1 is a flowchart illustrating an exemplary method 100 for automatically allocating a task to a resource, according to an exemplary embodiment of the present disclosure. The operations of method 100 presented below are intended to be illustrative. In some implementations, method 100 may be accomplished with one or more additional operations not described and/or without one or more of the operations discussed. Additionally, the order in which the operations of method 100 are illustrated in FIG. 1 and described below is not intended to be limiting.

In some implementations, method 100 may be implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 includes storing hypergraph information and a machine learning model. In some implementations, the said hypergraph information and the said machine learning model may be stored in a set of one or more computer-readable storage media. A hypergraph may be a knowledge graph having edges that can connect to a subset of nodes. Standard knowledge graphs may only be capable of connecting two nodes via one edge. A hypergraph may enable storage of events and/or concepts involving more than one conceptual relationship.

In some implementations, the said hypergraph information characterizes a task management environment. The hypergraph information may include computer-readable information characterizing a hypergraph. The said hypergraph may characterize relationships and/or associations within the said task management environment. By way of non-limiting example, the said hypergraph information may characterize at least one of a preference for a resource, a pattern of a resource, a reason for a previous task allocation to a resource being rejected, a status of a resource, and/or other information. For example, the event of a first person selling a second person their car for $1000 involves more than one conceptual relationship. A hypergraph may be equivalent to a connected neighborhood of a knowledge graph (i.e., a subgraph) that includes multiple nodes and one relationship amongst the nodes. In some implementations, events within the task management environment may be considered as associations represented by the said hypergraph.

In some implementations, the said machine learning model is configured to output task allocations for the said task management environment responsive to receipt of information indicating a change to the said task management environment. By way of non-limiting example, the said machine learning model may be a large language model. Suitable large language models may include but are not limited to Bidirectional Encoder Representations from Transformers (BERT), a Generative Pre-trained Transformer (GPT), Falcon, Llama, Cohere, Claude, Gemini, and/or other large language models.

In some implementations, the said machine learning model is configured to generate a natural language output responsive to receipt of a natural language input. In some implementations, the said machine learning model is configured to generate a recommendation based on the said workflow information and the said hypergraph information. In some implementations, an individual task allocation identifies one or more resources to complete and/or assist in completion of an individual task. For example, a candidate task allocation may identify an individual team member to be assigned to complete a task. As another example, a candidate task allocation may identify an airplane to be assigned to being used for a particular route.

In various embodiments, a vector of features that includes the machine learning model input(s) may be provided to one or more of the machine learning models described herein. As used herein, reference to providing information as input to a machine learning model may refer to providing a vector representation of information as input to the machine learning model. Based on the input features, one or more of the machine learning models described herein may generate one or more outputs. In some embodiments, the output(s) of the one or more machine learning models described herein may be a vector of features.

In some implementations where the machine learning model is configured for natural language processing (e.g., a large language model), a vector of features may be a representation of text. In some implementations, the said vector of features may have been generated using tokenization. In some implementations, a vector of features output by a machine learning model configured for natural language processing may be a token vector including numerical representations of the meaning of tokens. By way of non-limiting example, the said token vector may be converted to a natural language representation. As used herein, references to “output” of a machine learning model may refer to the vector of features and/or a natural language representation of the said vector of features.

An operation 104 may include receiving workflow information characterizing one or more updates to the said task management environment. In some implementations, the said updates may include one or more of a task to be allocated to at least one resource, a change to a pre-existing task, a change to a resource in the task management environment, and/or other changes to the task management environment. By way of non-limiting example, the said workflow information may characterize one or more characteristics of the said task, a status of a resource in the task management environment, and/or other information. For example, the said one or more characteristics may include a due date, a time frame, a start date, an urgency level, a description, a magnitude, a budget, a time allotment, a description of requirements for completion, and/or other characteristics of the task. For example, the said status may include a skill level of the resource, an availability level of the resource, a schedule for the resource, a location of the resource, an interest level of the resource, an efficiency of the resource, a speed of the resource, a reason for previously rejecting an allocation of another task, and/or other information. In some implementations, the said workflow information may include a natural language indication of the said one or more updates.

In some implementations, the said workflow information may have been manually entered by a user to a system, retrieved from an application, retrieved from a social media profile, retrieved from a public store of information, and/or retrieved from a private store of information. By way of non-limiting example, workflow information entered manually by the said user may be received from a client computing platform associated with the said user via one or more servers. By way of non-limiting example, workflow information retrieved from an application and/or a social media profile may include updates published by and/or about resource within the task management environment. For example, such workflow information may include a post on a social media platform describing a new skill a member of a task management environment has attained. By way of non-limiting example, the said workflow information may include weather information from a public data store. In some implementations, the said workflow information may include sensor information. By way of non-limiting example, receiving workflow information including sensor information may include receiving sensor information captured by one or more sensors. For example, the said sensor information may characterize a status of a resource and/or another entity impacting the task management environment.

Operation 106 includes providing the said workflow information as input to the said machine learning model. An operation 108 may include generating recommendations based on the said workflow information and the said hypergraph information. By way of non-limiting example, the said recommendations may include one or more of candidate task allocation(s), rationale(s) for the said candidate task allocations, recommendation(s) for resources, recommendation(s) for the said task management environment, and/or other information. By way of non-limiting example, the said candidate task allocation may be generated based on at least a reason for a previous task allocation to an individual resource being rejected. For example, more than one candidate task allocation may be generated to provide potential alternatives for task allocations. In some implementations, the recommendation may include an indication of a preferred or most recommended task allocation. By way of non-limiting example, it may be beneficial for the machine learning model to generate more than one candidate task allocation due to a characteristic of a task and/or a resource. For example, a task may require travel, which in turn requires an individual to consent to the travel. In the case the individual denies traveling, an alternative task allocation may have already been recommended without the need for the machine learning model to process the information again. In some implementations, the machine learning model may be configured to generate a number of candidate task allocations within a particular upper bound. In some implementations, the said number of candidate task allocations may be determined manually. For example, the upper bound may be 1, 5, 10, 12, and/or any other real number.

By way of non-limiting example, a rationale for a candidate task allocation may include a reason why the said candidate task allocation may be more likely to result in sufficient completion of a task by a particular resource identified by the said candidate task allocation. By way of non-limiting example, a candidate task allocation may identify a first team member to complete a first task. For further example, a recommendation may suggest to a supervisor to have a second team member train the said first team member on a particular skill prior to and/or during assignment of the said first team member to the said first task.

In some implementations, the said recommendations may be natural language recommendations generated by the said machine learning model. In some implementations, the said candidate task allocation may be generated by the said machine learning model.

Operation 110 includes updating the said hypergraph information in accordance with the said workflow information. Updating the said hypergraph information may include adding, deleting, and/or modifying associations characterized by the hypergraph information. In some implementations, the hypergraph information may be updated such that some or all of the said updates are reflected by the hypergraph information. In some implementations, the hypergraph information may be updated by the said machine learning model, another machine learning model, a computer processor, and/or another component. In some implementations, additions to, deletions of, and/or modifications of the said associations may be generated by the said machine learning model and/or another machine learning model.

An operation 112 may include determining a weight for each of the said one or more updates. By way of non-limiting example, the weights may characterize an importance of the updates, a particular characteristic of the updates, and/or other information. In some implementations, determining the said weight for each of the said one or more updates may include generating contextual information for each of the said updates. By way of non-limiting example, the said contextual information may be generated by the said machine learning model. In some implementations, determining the said weight for each of the said one or more updates may include generating a memory token for each of the said updates. By way of non-limiting example, the said memory token may be generated by the said machine learning model.

As used herein, “memory tokens” may refer to tokens within the machine learning model's architecture that hold contextual information from the said workflow information. Memory tokens may be designed to capture and retain information from the said workflow information to the machine learning model. The machine learning model may be enabled to access the information and generate outputs in accordance with the memory tokens. Memory tokens may initially be populated with information from the said workflow information. By way of non-limiting example, the machine learning model may be configured to process memory tokens of the said workflow information in a hierarchical manner. For example, a memory token may represent the said workflow information directly. For example, a memory token may represent contextual workflow information derived from the said workflow information. In some implementations, the machine learning model may access and use the memory tokens to understand and contextualize the said workflow information. Use of memory tokens may enable the machine learning model to generate output in accordance with dependencies, relationships, and nuances within the said workflow information. In some implementations, the machine learning model may be configured to refer to the memory tokens to maintain coherence and consistency with the said workflow information.

In some implementations, an individual memory token for an update may represent contextual information of a first update, contextual information of a portion of the said workflow information corresponding to the said first update, and/or other information. In some implementations, determining the weight for each of the one or more updates may include determining a weight for each of the memory tokens. In some implementations, the weight of an individual memory token may be related, in whole or in part, to the duration of time the individual memory token was included in the said machine learning model. For example, newer memory tokens may have a higher weight than older memory tokens.

An operation 114 may include selecting an individual update of the said one or more updates such that the said weight of the said individual update satisfying a weight threshold. In some implementations, satisfying the weight threshold may include the said weight being greater than, less than, and/or equal to the weight threshold. By way of non-limiting example, the weight threshold may have been set such that a particular number of updates may be selected. By way of non-limiting example, no updates may be selected by virtue of no updates having a weight satisfying the weight threshold.

An operation 116 may include updating the said machine learning model to reflect the said individual update. In some implementations, updating the said machine learning model to reflect the selected update may include storing memory tokens associated with the selected update in the said machine learning model. By way of non-limiting example, the said machine learning model may not be updated by virtue of no updates having been selected.

In some implementations, updating the said machine learning model may include allocating additional memory space to the said machine learning model. By way of non-limiting example, allocating additional memory space to the machine learning model includes increasing capacity of the machine learning model. Increasing capacity of the machine learning model may enable more information to be encoded by the machine learning model. By way of non-limiting example, the additional memory space may be allocated in a set of one or more computer-readable storage media. In some implementations, updating the said machine learning model may include determining an updated weight for a memory token. In some implementations, updating the said machine learning model may include removing the said memory token from the said machine learning model. By way of non-limiting example, removing the said memory token from the said machine learning model may include removing an association between the said machine learning model and storage location(s) in the said set of one or more computer-readable storage media. By way of non-limiting example, the said memory token may be removed responsive to determining the said updated weight is less than a removal threshold.

In some implementations, the ratio of memory size of the said machine learning model to the number of memory tokens currently stored in the said machine learning model may be maximized. In some implementations, the ratio of the sum of the said memory size and a number of configurations to the said number of memory tokens may be maximized. By way of non-limiting example, such ratios may be maximized by allocating additional memory space to the said machine learning model. By way of non-limiting example, such ratios may be maximized by removing one or more memory tokens from the said machine learning model. In some implementations, updating the hypergraph information may include removing a particular number of memory tokens from the said machine learning model. In some implementations, the oldest memory tokens may be removed from the said machine learning model prior to newer memory tokens.

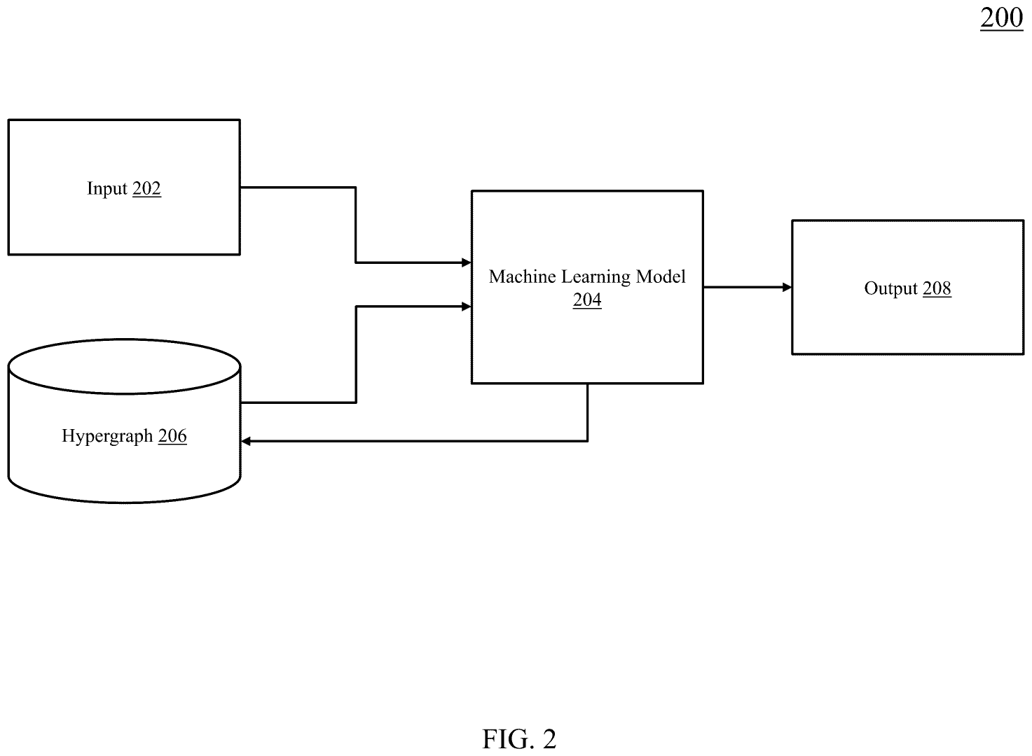

FIG. 2 illustrates a block diagram demonstrating a process for generating recommendations for a task management environment. An exemplary process 200 may include the use of an input 202, a hypergraph 206, a machine learning model 204, and an output 208. Hypergraph 206 may refer computer-readable information characterizing a hypergraph. In some implementations, input 202 and hypergraph 206 may be provided to machine learning model 204 as input. By way of non-limiting example, machine learning model 204 may be a trained machine learning model using a text encoder (e.g., the encoder of a transformer architecture).

For further example, input 202 and hypergraph 206 may be provided to the encoder of machine learning model 204 during training and/or use of machine learning model 204. In some implementations, machine learning model 204 may include a hypergraph encoder and/or one or more hypergraph layers configured to adapt hypergraph 206 for processing by machine learning model 204. By way of non-limiting example, the said hypergraph encoder and/or hypergraph layer(s) may be configured to extract meaning from hypergraph 206.

In some implementations, machine learning model 204 may be configured to generate an output 208 responsive to receipt of input 202 and hypergraph 206. By way of non-limiting example, output 208 may include and/or indicate the said recommendations for the said task management environment. Machine learning model 204 may be configured to update hypergraph 206 to reflect updates to the task management environment. The updates to the task management environment may have been characterized by input 202. Machine learning model 204 may self-update such that machine learning model 204 reflects a subset of the said updates after self-update.

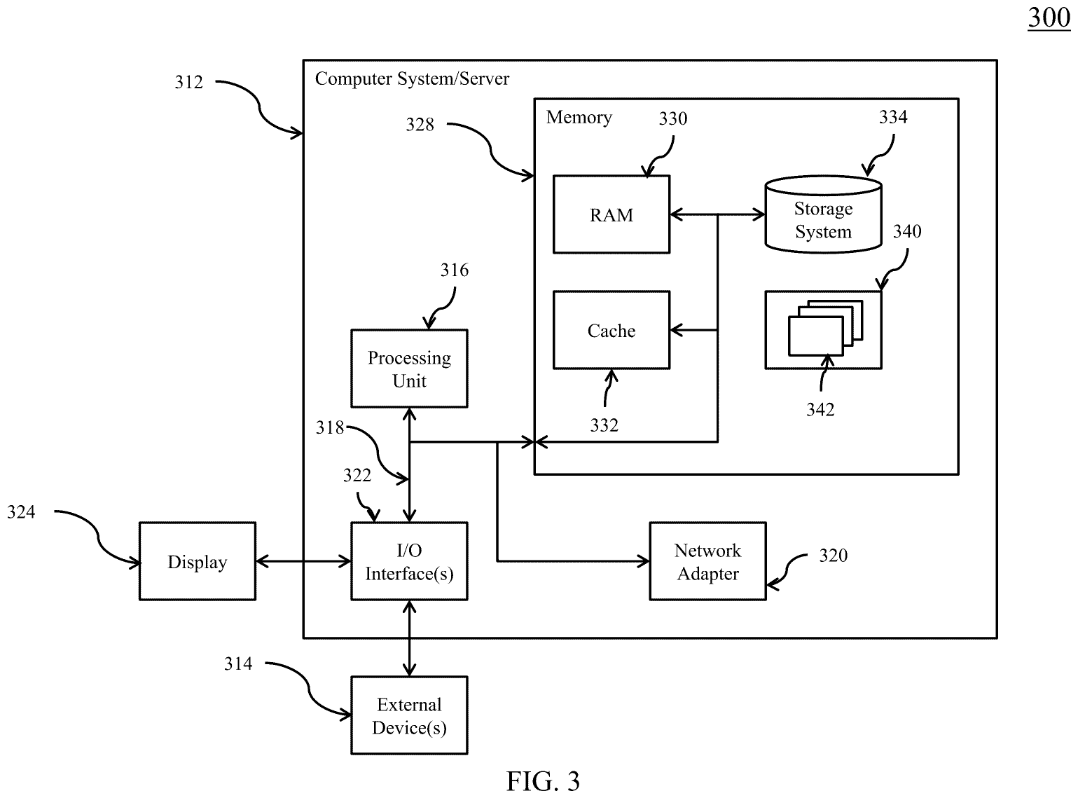

Referring now to FIG. 3, a schematic of an example of a computing node is shown. Computing node 310 is only one example of a suitable computing node and is not intended to suggest any limitation as to the scope of use or functionality of embodiments described herein. Regardless, computing node 310 is capable of being implemented and/or performing any of the functionality set forth hereinabove.

In computing node 310 there is a computer system/server 312, which is operational with numerous other general purpose or special purpose computing system environments or configurations. Examples of well-known computing systems, environments, and/or configurations that may be suitable for use with computer system/server 312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 312 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 312 in computing node 310 is shown in the form of a general-purpose computing device. The components of computer system/server 312 may include, but are not limited to, one or more processors or processing units 316, a system memory 328, and a bus 318 that couples various system components including system memory 328 to processor 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 312 typically includes a variety of computer system readable media. Such media may be any available media that is accessible by computer system/server 312, and it includes both volatile and non-volatile media, removable and non-removable media.

System memory 328 can include computer system readable media in the form of volatile memory, such as random access memory (RAM) 330 and/or cache memory 332.

Computer system/server 312 may further include other removable/non-removable, volatile/non-volatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 may include at least one program product having a set (e.g., at least one) of program modules that are configured to carry out the functions of embodiments of the disclosure.

Program/utility 340, having a set (at least one) of program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments as described herein.

Computer system/server 312 may also communicate with one or more external devices 314 such as a keyboard, a pointing device, a display 324, etc.; one or more devices that enable a user to interact with computer system/server 312; and/or any devices (e.g., network card, modem, etc.) that enable computer system/server 312 to communicate with one or more other computing devices. Such communication can occur via Input/Output (I/O) interfaces 322. Still yet, computer system/server 312 can communicate with one or more networks such as a local area network (LAN), a general wide area network (WAN), and/or a public network (e.g., the Internet) via network adapter 320. As depicted, network adapter 320 communicates with the other components of computer system/server 312 via bus 318. It should be understood that although not shown, other hardware and/or software components could be used in conjunction with computer system/server 312. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference has been made in detail herein to the exemplary embodiments of the present disclosure, examples of which are illustrated in the accompanying drawings. The systems, devices, and methods disclosed herein are described in detail by way of examples, and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

For any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for automatically allocating tasks to resources using a machine learning model and a hypergraph, the computer-implemented method comprising:
receiving, from a client computing platform, workflow information characterizing one or more updates to a task management environment, wherein the updates include a task to be allocated to at least one resource;
providing the workflow information as input to a machine learning model configured to output task allocations for the task management environment responsive to receipt of information indicating a change to the task management environment to the task management environment;
generating, by the machine learning model, a candidate task allocation based on the workflow information and hypergraph information characterizing the task management environment;
updating the hypergraph information in accordance with the workflow information;
determining a weight for each of the one or more updates;
selecting an individual update of the one or more updates such that the weight of the individual update is greater than or equal to a weight threshold; and
updating the machine learning model to reflect the individual update.

2. The method of claim 1, wherein:
the hypergraph information characterizes at least one of a preference for an individual resource, a pattern of the individual resource, a reason for a task allocation to the individual resource being rejected, and a status of the individual resource.

3. The method of claim 2, wherein:
the candidate task allocation is based on at least the reason for the task allocation to the individual resource being rejected.

4. The method of claim 1, wherein:
the machine learning model is a large language model, and the machine learning model is configured to generate a natural language output responsive to receipt of a natural language input.

5. The method of claim 1, further comprising:
receiving sensor information captured by one or more sensors; and
updating the hypergraph information based on the sensor information.

6. The method of claim 1, wherein:
the generating of the candidate task allocation includes generating, by the machine learning model, a rationale for the candidate task allocation based on the workflow information and the hypergraph information.

7. The method of claim 1, wherein:
the determining of the weight for each of the one or more updates includes:
generating, by the machine learning model, contextual information for each of the updates,
generating, by the machine learning model, a memory token for each of the updates, wherein an individual memory token for the individual update represents contextual information of a first update or a portion of the workflow information corresponding to the first update, and
determining a weight for each of the memory tokens.

8. The method of claim 7, wherein:
the updating of the machine learning model to reflect the individual update includes encoding the individual memory token in the machine learning model.

9. The method of claim 8, further comprising:
increasing capacity of the machine learning model;
determining an updated weight for the individual memory token; and
removing the individual memory token from the machine learning model, responsive to determining the updated weight is less than a removal threshold.

10. The method of claim 1, wherein:
the resource is selected from the group consisting of one or more people, one or more locations, and one or more objects.

11. A computer program product for automatically allocating tasks to resources using a machine learning model and a hypergraph, the computer program product comprising:
a set of one or more computer-readable storage media; and
program instructions, collectively stored in the set of one or more storage media for causing the processor set to perform the following computer operations:
receive, from a client computing platform, workflow information characterizing one or more updates to a task management environment, wherein the updates include a task to be allocated to at least one resource;
provide the workflow information as input to a machine learning model configured to output task allocations for the task management environment responsive to receipt of information indicating a change to the task management environment to the task management environment;
generate, by the machine learning model, a candidate task allocation based on the workflow information and hypergraph information characterizing the task management environment;
update the hypergraph information in accordance with the workflow information;
determine a weight for each of the one or more updates;
select an individual update of the one or more updates such that the weight of the individual update is greater than or equal to a weight threshold; and
update the machine learning model to reflect the individual update.

12. The computer program product of claim 11, wherein:
the candidate task allocation is based on at least a reason for the task allocation to the individual resource being rejected.

13. The computer program product of claim 11, wherein the program instructions are further for causing the processor to perform the following computer operations:
receive sensor information captured by one or more sensors; and
update the hypergraph information based on the sensor information.

14. The computer program product of claim 11, wherein
the determining of the weight for each of the one or more updates incudes:
generating, by the machine learning model, contextual information for each of the updates,
generating, by the machine learning model, a memory token for each of the updates, wherein an individual memory token for the individual update represents contextual information of a first update or a portion of the workflow information corresponding to the first update, and
determining a weight for each of the memory tokens.

15. The computer program product of claim 14, wherein:
the updating of the machine learning model to reflect the individual update includes encoding the memory token in the machine learning model.

16. A computer system for automatically allocating tasks to resources using a machine learning model and a hypergraph, the computer system comprising:
a processor set;
a set of one or more computer-readable storage media; and
program instructions, collectively stored in the set of one or more storage media for causing the processor set to perform the following computer operations:
receive, from a client computing platform, workflow information characterizing one or more updates to a task management environment, wherein the updates include a task to be allocated to at least one resource;
provide the workflow information as input to a machine learning model configured to output task allocations for the task management environment responsive to receipt of information indicating a change to the task management environment to the task management environment;
generate, by the machine learning model, a candidate task allocation based on the workflow information and hypergraph information characterizing the task management environment;
update the hypergraph information in accordance with the workflow information;
determine a weight for each of the one or more updates;
select an individual update of the one or more updates such that the weight of the individual update is greater than or equal to a weight threshold; and
update the machine learning model to reflect the individual update.

17. The computer system of claim 16, wherein:
the candidate task allocation is based on at least a reason for the task allocation to the individual resource being rejected.

18. The computer system of claim 16, wherein the program instructions are further for causing the processor to perform the following computer operations:
receive sensor information captured by one or more sensors; and
update the hypergraph information based on the sensor information.

19. The computer system of claim 16, wherein
the determining of the weight for each of the one or more updates incudes:
generating, by the machine learning model, contextual information for each of the updates,
generating, by the machine learning model, a memory token for each of the updates, wherein an individual memory token for the individual update represents contextual information of a first update or a portion of the workflow information corresponding to the first update, and
determining a weight for each of the memory tokens.

20. The computer system of claim 19, wherein:
the updating of the machine learning model to reflect the individual update includes encoding the memory token in the machine learning model.
